(19) United States
(12) Patent Application Publication
(10) Pub. No.: US 2022/0261975 A1
(43) Pub. Date: Aug. 18, 2022

(54) INSPECTION METHOD AND APPARATUS

(71) Applicant: Hewlett-Packard Development Company, L.P., Spring, TX (US)

(72) Inventors: Yaron Hershman, Ness Ziona (IL); Avi Malki, Ness Ziona (IL); Michal Hod, Ness Ziona (IL)

(73) Assignee: Hewlett-Packard Development Company, L.P., Spring, TX (US)

(21) Appl. No.: 17/628,665

(22) PCT Filed: Oct. 2, 2019
(86) PCT No.: PCT/US2019/054269

§ 371 Date: Jan. 20, 2022

(51) Int. Cl. G06T 7/00; G06T 7/11; G06T 7/13; G06F 3/12

(52) U.S. Cl. CPC G06T 7/001; G06T 7/11; G06T 7/13; G06T 2207/20104; G06F 3/1259; G06T 2207/30144; G06F 3/1219

(57) ABSTRACT

The group of inventions solves the problem in processing defects in printed images. The printed image inspection method and an inspection apparatus comprise: determining a region of interest corresponding to printed images having respective identifiers by detecting boundaries in a printed calibration image; capturing target images of the printed images using the region of interest; comparing pixels in the target images with pixels in image data corresponding to the printed images in order to identify printed images having a print defect using the identifiers.

### BACKGROUND

Defects in printed images can be caused by a number of factors including anomalies in print medium, interactions between print medium ad marking material, systematic defects introduced by print mechanism or human error. Image defects may include but are not limited to scratches, spots, missing dot clusters, streaks, and banding. Automated inspection systems may be used in commercial printing applications where a printing press may operate at speeds in excess of two meters per second.

### BRIEF DESCRIPTION OF THE DRAWINGS

Examples are further described hereinafter with reference to the accompanying drawings, in which:

FIG. 1 is a schematic diagram of a printing system according to an example;

FIG. 2 is a schematic diagram illustrating inspecting a printed image according to an example;

FIG. 3 is a flow chart illustrating a method of inspecting a printed image according to an example;

FIG. 4 is a schematic diagram illustrating a method of determining regions of interest in a printed image according to an example; and

FIG. 5 is a schematic diagram of a non-transitory computer readable storage medium according to an example.

### DETAILED DESCRIPTION

Certain examples described herein address a challenge when handing print defects in printing systems of minimizing waste of printing substrates such as paper or textiles and/or printing fluids such as ink or dyes. When a print defect is detected by an inspection system, typically the entire print medium, for example a sheet of paper containing an image, is discarded. However, when printing labels or other images that may not extend fully over the print medium, the image may be cut from the print medium following printing. Certain examples described herein enable discrimination between print defects within a region of interest (ROI) corresponding to a printed image such as a label, and those outside of the ROI. Further, when some but not all ROI contain print defects, the ROI containing print defects may be discarded and the ROI with no print defects may be kept; rather than discard an entire print medium or sheet containing a print defect but also containing some ROI without print defects. These examples therefore reduce waste of printing substrates and/or printing fluids or other materials such as priming and finishing agents. These substrates, fluids and other materials may be expensive, and in commercial printing applications may result in large costs.

Certain examples described herein address a challenge when inspecting ROI for print defects of reducing operator setup time. The operator may need to manually draw the outlines of ROI for an inspection system to inspect. This requires the operator to open the print job data in an inspection system operating application, print samples, scan and draw inspection lines around the ROI. This is time consuming and also requires operator skill and knowledge. Certain examples described herein provide an automated method of identifying print defects within ROI (regions of interest which correspond to printed images such as labels). Each printed image may be uniquely identifiable, for example using a barcode, so that it can be processed downstream of the inspection system in a way that depends on whether it contains a print defect.

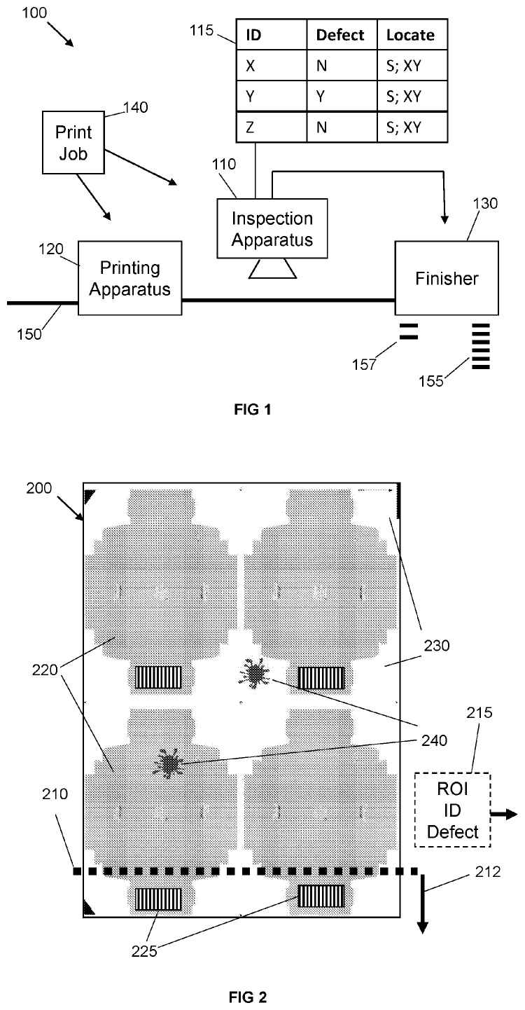

FIG. 1 shows a printing system 100 according to an example. Certain examples described herein may be implemented within the context of this printing system. However, it should be noted that implementations may vary from the example system of FIG. 1.

The printing system 100 may comprise a printing apparatus 120, for example a digital press printer. An example of a digital press printer that may be employed is a digital offset press printer, for example a Liquid Electro-Photographic (LEP) printer. A printing apparatus 120 such as that described in patent publication US2012/0070040 may be used, although any suitable printing apparatus may alternatively be used. An example of a commercially available printing apparatus that may be used is the HP Indigo 20000 digital press from Hewlett Packard. The printing apparatus 120 may receive print job data 140 containing digital image data corresponding to one or more image to be printed onto a substrate 150 such as paper, which may be provided as discrete sheets or in a continuous run that may later be cut into sheets.

The print job data may be in any suitable format useable by the printing apparatus 120 to print the images. This may include a raster image of each image to be printed, such as a label. The printed label may include a unique identifier such as a barcode. The job data may also include diecut or cut and crease line data for cutting and folding the labels. These may be provided as dimension data for use by a downstream process or may be provided as image data that can be printed onto an initial lead-in sheet without labels but including the outlines of all labels (the diecut lines).

The printing system 100 may comprise an inspection apparatus 110 which identifies print defects on the printed substrate 150. The inspection apparatus may include an image capture assembly such as photosensors, LEDs, laser diodes, scanners etc. The apparatus 110 may also comprise a processor and memory configured to analyze the captured images to identify print defects such as scratches, spots, missing dot clusters, streaks, and banding. An inspection apparatus 110 such as that described in patent publication US2012/0070040, may be used to identify print defects, although any suitable printing apparatus may alternatively be used. The inspection apparatus 110 receives the print job data 140 so that pixels of images in the print job data can be compared with corresponding pixels in the captured images of the printed images to determine whether they are sufficiently similar or whether they indicate a print defect.

The inspection apparatus 110 may be automatically configured to distinguish between print defects within an ROI and those outside of an ROI and to identify defective ROI—that is ROI containing a print defect. This may be achieved by reading an identifier printed in each ROI and associating this with print defect information in a data-structure 115. The identifier may be a barcode printed within the ROI and this may be stored in the data structure 115 together with an indication of whether the corresponding ROI contains a print defect. The data structure 115 may also or alternatively contain a sheet reference number S and coordinates on the sheet XY to identify the ROI.

In an alternative example, the printed identifiers such as barcodes may be printed outside the printed image or label so that they do not fall within the region of interest (ROI). This may be implemented by searching for and reading any barcode on each sheet and correlating this with the closest ROI or printed image.

The printing system 100 may also comprise a finisher 130 which cuts the ROI or printed image according to the diecut lines, may fold the printed image according to crease lines, and discards printed images having print defects. The finisher 130 may also apply various finishing processes to the printed images including curing. A commercially available example of a finisher is the Digicon 3000 from Edale, although other finishers may alternatively be used. The finisher 130 may output finished labels 155 without print defects and may discard labels 157 having print defects. The finisher may identifier individual printed images by reading their identifiers e.g. barcodes and may consult the data-structure 115 to determine whether or not each printed image has a print defect and therefore whether or not to discard an individual label.

FIG. 2 illustrates the identification of defective regions of interest using the inspection apparatus 115. A sheet 200 of printing substrate such as paper or textile is shown. The sheet 200 may be a discrete sheet physically separated from other sheets or it may be a virtual sheet on a continuous run of substrate 150 which will be cut into a physically separated sheet in a downstream process, for example in the finisher 130. Each sheet 200 contains a number of printed images 220 such as labels. Each printed image 220 contains a printed identifier 225 which may be any printed code such as a barcode. The identifier 225 uniquely identifies each printed image 220. Around the printed images 220 is unused substrate 230, and the printed sheet 200 may contain one or more print defects 240.

The inspection apparatus 110 or inline scanner scans the printed sheet 200 as indicated by scan line 210 along the direction of movement of the sheet indicated by 212. The inspection apparatus 110 defines regions of interest (ROI) registered with the location of the printed images on each sheet 200 in order to capture a target image for each ROI which should correspond with each printed image 220. The mechanism for automatically defining each ROI is described in more detail below. Information 215 such as ROI, identifier read from the printed barcode and defect data for each ROI may be provided to the data structure 115.

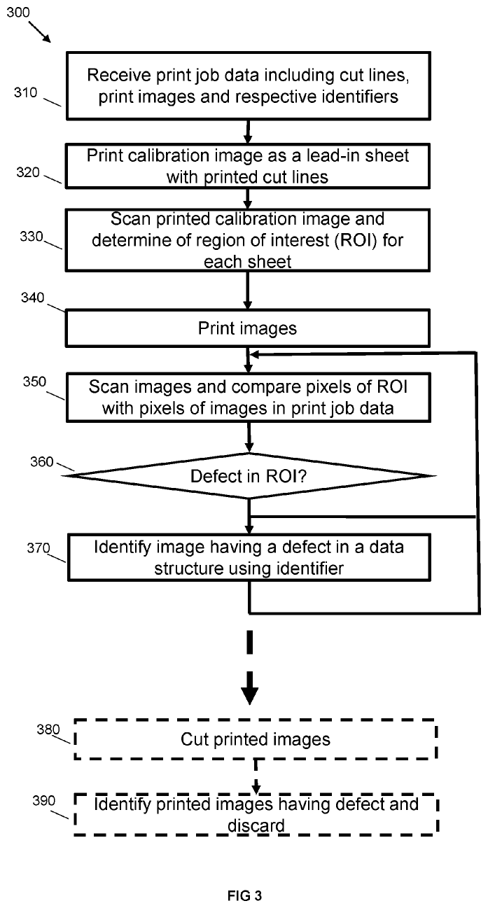

FIG. 3 illustrates an inspection method according to an example. In some examples, some of the method 300 may be performed by an inspection apparatus such as inspection apparatus 110 and a printing apparatus such as the printing apparatus 120. The inspection apparatus may instruct other apparatus to perform some parts of the method. The inspection apparatus may perform the method based on instructions retrieved from a computer-readable storage medium.

At block 310, print job data may be received from another process or from a customer. The print job data may contain print images such as labels each having a unique identifier which may be image data corresponding to a barcode for example which is printed by a printing apparatus. The print job data also comprises cut-lines which may be used by a downstream process such as the finisher 130 to cut the printed images into individual labels. The print job data may contain other finishing information such as crease lines for folding the labels and instructions on finishing processes to be applied such as curing.

At block 320, a calibration image is printed which contains printed boundaries corresponding to the positions of the printed images on the sheets. In an example a printed calibration may be a lead-in sheet which is printed with the cut lines printed in a printing fluid that is visible to the inspection apparatus. However, any suitable calibration image may alternatively be used, for example containing die cut or cutmarks. The cut lines or other calibration lines form one or more closed areas corresponding to the areas of the printed images such as labels. The cut lines may need to be converted to visible lines in a printable image. In an example the inspection apparatus 110 may instruct the printer apparatus 120 to print the lead-in sheet.

At block 330, the printed calibration image or lead-in sheet is scanned to define one or more regions of interest (ROI) in each sheet 200. The ROI are determined by detecting boundaries for the printed images using the printed calibration or lead-in sheet as described in more detail below. The ROI allow the boundary of the printed images to be known by the inspection apparatus so that any print defects detected within the ROI can be associated with individually identified printed images. This allows printed images having print defects to be identified by downstream processes so that they can be discarded. This also allows those printed images to be identified for reprinting.

At block 340, the images in the job data are printed, together with their identifiers. In an example, following determination of the ROI, the inspection apparatus 110 may instruct the printing apparatus 120 to print the images in the print job data.

At block 350, the printed images are scanned and pixels in ROI are compared with corresponding pixels of print images in the print job data. The ROI of each scanned target or captured image is to be compared with a corresponding print image in the image data. In an example, this is implemented using the method described in US2012/0070040 which compares pixel values in raster images in image data of the labels with scanned pixel values in the ROI; for example the intensity and/or density of each pixel. Color may also be compared, for example by converting the CMYK color space of the images to RGB color space for comparing with the scanned images. However different methods of comparing the scanned ROI with corresponding image data may alternatively be used.

The printed identifier such as a barcode may be read by any suitable algorithm to determine an identifier such as a number or code corresponding to the printed barcode and that is used to uniquely identify each printed and scanned image.

In block 360, the method determines whether each ROI in a sheet has a print defect. This may be determined when one or more pixel values of the ROI differ by more than a threshold against the corresponding pixels values of the image data. If no print defects are identified in the ROI of the sheet, the method returns to block 345 where the next sheet is scanned.

At block 370, when a print defect in an ROI is determined, the printed image having the defect is identified using the respective identifier of the printed image. In an example this is achieved by associating the printed image having a defect with its identifier in a data structure 115. The printed identifier 225 may be a barcode which is read and interpreted by the scanning apparatus 110 to determine the corresponding unique identifier which may be a number for example. These numbers or identifiers (ID) may be stored in the data structure 115 to identify the printed images such as labels containing a printing defect. The data structure may be used to discard and reprint those printed images. The data structure 115 may store only the identifiers of the printed images containing printing defects, or it may store all printed image identifiers together with an indication of whether or not the corresponding printed image contains a print defect. The data structure may also store information about the location of the printed image, for example the sheet number and an approximate location on the sheet to help with identifying the correct printed image in a downstream process.

The inspection apparatus may contain cutting and manipulating components or these may be provided in a separate apparatus such as the finisher 130, in which case the separate apparatus has access to the data structure 115 or is sent the data structure by the inspection apparatus.

At block 380, the printed images are cut from the sheets to separate them into individual printed images such as labels. This may be achieved using the cut lines in the print job data and may be implemented using rotary blades in the direction of movement of the printing substrate and a reciprocating action for cutting in the transverse direction once individual sheets have been separated. The printing substrate not forming printed images may then be discarded using any suitable process, for example printed images may be cut out and dropped onto a conveyor belt whilst the remaining printing substrate is mechanically directed to a waste bin.

At block 390, the separated printed images are scanned by a scanner to read their printed identifiers. Any printed images having identifiers corresponding to a printed image having a print defect in the data structure are discarded. This may be achieved by any suitable means, for example a mechanical arm with suction removing the defective labels from a stream of such labels on a conveyor, or a rotary jog mechanism interrupting conveyance of printed images having defects. The identified defective labels may then be reprinted, for example by the printing apparatus 120. This may be implemented by a separate planning and control system in which any printed image which is declared defective is automatically sent to the printing apparatus to be printed again.

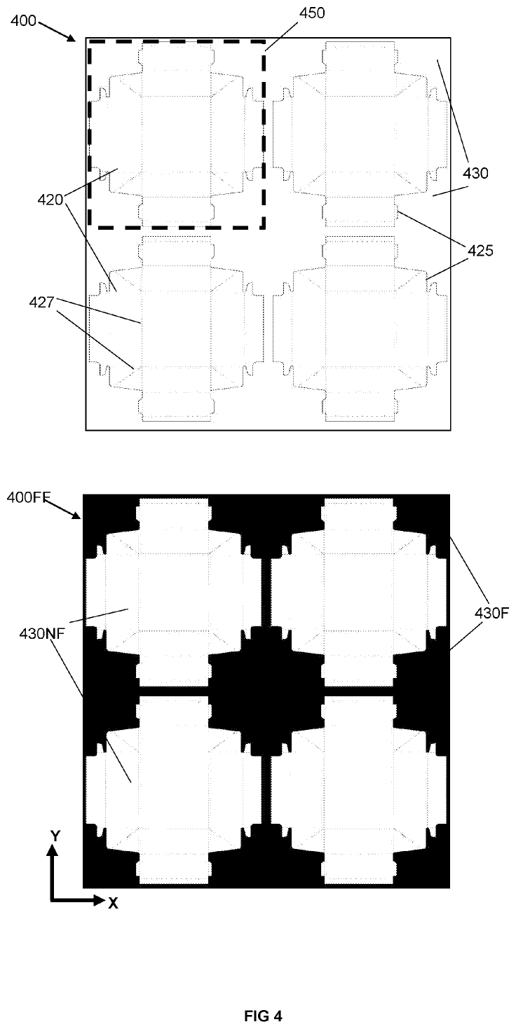

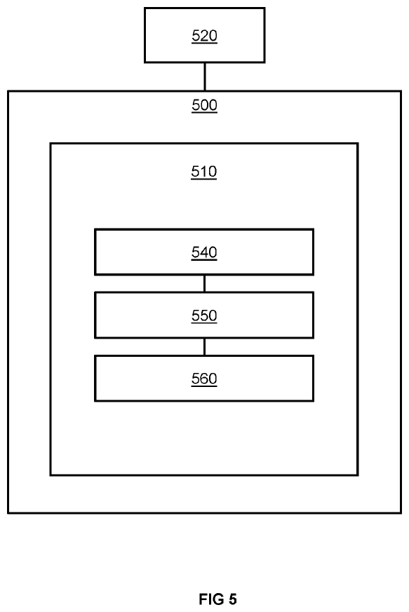

An example algorithm for an inspection apparatus to automatically determine the ROI of block 330 is described with respect to FIG. 4 which illustrates a printed calibration image, in this example in the form of a lead-in sheet. The lead-in sheet 400 is a sheet of printing substrate such as paper which is the same size as the sheets used to print the printed images, for example size A4. The lead-in sheet 400 contains regions of interest (ROI) 420 which correspond to the size, location and shape of the printed images such as labels. These ROI have printed lines or boundaries 425 corresponding to the diecut lines of the print job data. These diecut or cut lines are not normally printed with the labels but are included with the print job data to instruct cutting of the labels from the sheets. By coloring these digital lines in the print job data, these diecut lines may be printed as visible lines on the lead-in sheet and used by the inspection apparatus to automatically determine the ROI which in turn are used by the scanning apparatus to align its imaging and comparison of the scanned pixels with the printed labels. The lead-in sheet 400 may also comprise other lines within the ROI such as fold and/or crease lines as shown. Outside of the ROI are areas of substrate 430 that will not contain printed images and may be discarded after printing.

The scanning or inspection apparatus scans the lead-in sheet to generate a digital image including the printed lines 425. In an example the inspection apparatus uses flood fill and projection algorithms to automatically detect boundaries for the printed images by detecting the locations of the closed areas defined by the printed scan lines 425. The flood fill algorithm is arranged to change the color of all pixels outside the ROI 420. The flood fill algorithm is known in image processing and may use as an origin or starting point a corner of the sheet. The flood fill algorithm then changes color (e.g. to black as shown) of the adjacent pixels in X and Y directions, bounded by the lines 425. This results in a digital image 400FF having black filled areas 430F and white (or another non-black color of the printing substrate) non-filled areas 430NF having the original color and corresponding to the ROI.

The ROI determining algorithm then using a projection algorithm to determine a bounding box for each ROI—an example illustrative bounding box is shown in dashed outline 450. The bounding box 450 is determined by scanning the lead-in sheet image 400FF in the X and Y axes to determine coordinates having any non-black pixels which indicates a ROI. For example, starting at the extreme left of the X axis, there are only black pixels. Moving right white pixels start indicating the left most X coordinate of a bounding box for an ROI. Moving further right, black only pixels again indicates the right most X coordinate of the bounding box. Moving further right, white pixels are again detected which indicates the start of another bounding box for another ROI. This process is also repeated in the Y axis to provide X and Y coordinates for the bounding boxes. Finally, the filled areas or black pixels are subtracted from the bounding boxes to determine the ROI having boundaries corresponding to the cut lines 425. These ROI are then used to determine the scanned pixels used to compare with the pixels of the image data to determine whether any print defects exist within the printed images.

Whilst the described ROI determining algorithm provides a simple and computational inexpensive method for determining the ROI, other methods of determining ROI may alternatively be used.

FIG. 5 shows a computer-readable storage medium 500, which may be arranged to implement certain examples described herein. The computer-readable storage medium 500 comprises a set of computer-readable instructions 510 stored thereon. The computer-readable instructions 510 may be executed by a processor 520 connectably coupled to the computer-readable storage medium 500. The processor 520 may be a processor of a printing system similar to printing system 100. In some examples, the processor 520 is a processor of an inspection apparatus such as inspection apparatus 110.

Instruction 540 instructs the processor 520 to determine a region of interest (ROI) corresponding to printed images having respective identifiers using a printed calibration image. The region of interest may be an area of a printed sheet containing a printed image and which has been determined using a lead-in sheet having printed cut lines corresponding to the area. The cut lines define closed areas which are automatically detected, for example using flood-fill and projection algorithms, and define the ROI The identifier may be a unique code or number contained in a printed code in the printed image, such as a barcode in a label.

Instruction 550 instructs the processor to capture a target image for the region of interest. The target image may be pixels of a scan of the entire sheet which fall within the ROI. The scan may comprise color pixels or grey level pixels.

Instruction 560 instructs the processor 520 to compare pixels in the target image with pixels in image data corresponding to the printed image in order to identify a printed image having a defect using the identifier. Detecting a defect may comprise comparing corresponding pixel values and identifying a printing image having a defect may comprise adding the identifier of the printed image to a data structure. The data structure may be used to identify printed images for discarding and/or reprinting.

The instructions may be used to determine ROI using a lead-in sheet and to then use the ROI to determine which parts of a printed sheet correspond to the printed images such as labels. The pixels of these parts can then be compared with their counterparts in the received image data to determine whether any of the printed images contain printing defects. A code reader can be used to determine the identifier of the printed images by reading the printed code (e.g. bar code) within the printed image (e.g. label). Any printed images having defects can then be identified by storing the read identifiers in a data structure.

Processor 520 can include a microprocessor, microcontroller, processor module or subsystem, programmable integrated circuit, programmable gate array, or another control or computing device. The computer-readable storage medium 600 can be implemented as one or multiple computer-readable storage media. The computer-readable storage medium 500 includes different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. The computer-readable instructions 510 can be stored on one computer-readable storage medium, or alternatively, can be stored on multiple computer-readable storage media. The computer-readable storage medium 500 or media can be located either in the printing system 100 or inspection apparatus 110 or located at a remote site from which computer-readable instructions can be downloaded over a network for execution by the processor 520.

Certain examples described herein enable automatic alignment of scanned pixels with image data pixels for comparison in order to identify print defects in regions of interest corresponding to printed images such as labels. This reduces the set-up time and skill otherwise required to ensure correct alignment in an inspection apparatus.

Certain examples described herein reduce the scanning and/or comparison load on the processor as only pixels in the ROI need be scanned and/or compared with the image data. This may enable faster production speeds as the workload of the inspection apparatus is reduced on a per sheet basis.

Certain examples described herein reduce the amount of printing substrate and/or printing fluids used as only printed images containing a print defect are discarded rather than an entire sheet which may contain many printed images.

The preceding description has been presented to illustrate and describe examples of the principles described. This description is not intended to be exhaustive or to limit these principles to any precise form disclosed. Many modifications and variations are possible in light of the above teaching.

What is claimed is:

1. A printed image inspection method, the method comprising:
determining a region of interest corresponding to printed images having respective identifiers by detecting boundaries in a printed calibration image;
capturing target images of the printed images using the region of interest;
comparing pixels in the target images with pixels in image data corresponding to the printed images in order to identify printed images having a print defect using the identifiers.

2. The method of claim 1, associating a printed image having a print defect with a respective identifier in a data structure.

3. The method of claim 1, cutting the printed image and discarding a printed image having a defect.

4. The method of claim 3, wherein printed images to discard are determined using the respective identifier.

5. The method of claim 1, wherein the identifier is a unique printed code printed in the printed image.

6. The method of claim 1, wherein the boundaries are detected by detecting printed lines in a scanned image of the printed calibration image, the printed lines corresponding to cut lines for the printed images.

7. The method of claim 6, wherein the printed lines form closed areas and the method comprises generating a mask for regions of the printed calibration image outside of the closed areas by determining pixels falling outside the closed areas.

8. The method of claim 7, wherein the mask is determined using a flood-fill algorithm and the boundaries are determined using a projection algorithm and the mask.

9. The method of claim 1, comprising receiving print job data having a plurality of images each corresponding to a label to be printed onto a printing substrate, the print job data also comprising cut lines for cutting the printing substrate into printed images.

10. An inspection apparatus comprising:
an imaging device to capture images of printed images having an identifier,
a processor to determine regions of interest corresponding to the printed images by detecting boundaries in a printed calibration image and to compare pixels in the regions of interest with pixels in image data corresponding to the printed images in order to identify printed images having a print defect using the identifier.

11. The apparatus of claim 10 comprising a storage medium to associate printed images having a print defect with their identifier.

12. The apparatus of claim 10, the processor to determine the regions of interest using a printed calibration image having printed lines corresponding to cut lines for the printed images.

13. The apparatus of claim 12, the processor to generate a mask for regions of the printed calibration image outside of the regions of interest using a flood-fill algorithm and to detect the boundaries using a projection algorithm and the mask

14. The apparatus of claim 10, comprising a cutting device to cut the printed image according to the cut lines and to discard printed images having a defect using their identifiers.

15. A non-transitory computer-readable storage medium storing instructions that, when executed by a processor, cause the processor to:
determine a region of interest for a printed image having a printed identifier by detecting boundaries in a printed calibration image;
capture a target image for the region of interest;
compare pixels in the target images with pixels in image data corresponding to the printed image in order to identify a printed image having a defect using the identifier.
